(19) United States
(12) Patent Application Publication
(10) Pub. No.: US 2016/0254528 A1
(43) Pub. Date: Sep. 1, 2016

(54) TWO-DIMENSIONAL NANOSHEETS AND METHODS OF MAKING AND USE THEREOF

(71) Applicant: Board of Regents, The University of Texas System, Austin, TX (US)

(72) Inventors: Guihua Yu, Austin, TX (US); Pan Xiong, Austin, TX (US); Lele Peng, Austin, TX (US)

(21) Appl. No.: 15/054,445

(22) Filed: Feb. 26, 2016

Related U.S. Application Data
(60) Provisional application No. 62/121,245, filed on Feb. 26, 2015.

(51) Int. Cl. H01M 4/133; C01G 45/02; C01G 51/04; C01G 53/04; H01M 10/0525; C01G 45/12; C01G 51/00; C01G 53/00; H01M 4/1393; H01M 4/04; C01G 9/02; C01G 49/02

(52) U.S. Cl. CPC H01M 4/133; C01G 9/02; C01G 45/02; C01G 51/04; C01G 53/04; C01G 49/02; C01G 45/1235; C01G 51/40; C01G 53/40; H01M 4/1393; H01M 4/0402; H01M 4/0471; H01M 10/0525; C01P 2004/24; C01P 2006/16; C01P 2006/12; C01P 2006/40; Y10S 977/755; Y10S 977/888; Y10S 977/932; B82Y 40/00

(57) ABSTRACT

Disclosed herein are two-dimensional (2D) nanosheets comprising a continuous transition metal oxide phase permeated by a plurality of pores. The plurality of pores can have an average characteristic dimension of from 1 nm to 30 nm. Also disclosed herein are methods of making the 2D nanosheets described herein. The 2D nanosheets can be prepared by reacting a graphene template with a transition metal compound to form a nanosheet precursor and calcining the nanosheet precursor to form the 2D nanosheet. Methods of use of the 2D nanosheets, for example as electrodes in batteries, are also described.

### CROSS-REFERENCE TO RELATED APPLICATIONS

This application claims the benefit of priority to U.S. Provisional Application No. 62/121,245, filed Feb. 26, 2015, which is hereby incorporated herein by reference in its entirety.

### BACKGROUND

Dimensionality can play a role in determining the fundamental properties of nanomaterials. Due to physical and chemical properties, such as quantum confinement and surface effects, two-dimensional (2D) nanosheet materials can show potential in a wide range of applications, such as electronics, optics, catalysis, energy storage, and environmental technologies. This has been highlighted over the past decade in graphene materials, which can exhibit enhanced properties compared to bulk graphite and other carbon nanomaterials.

Transition metal oxides are a family of materials that can be used in a broad range applications, for example catalysis, energy storage, and energy conversion technologies. Transition metal oxide nanomaterials are typically obtained in the form of zero-dimensional (0D) nanoparticles, 1D nanotubes or nanowires, and 3D nanoclusters or microspheres. In contrast, 2D transition metal oxide nanostructures have remained a challenge.

### SUMMARY

Disclosed herein are two-dimensional (2D) nanosheets comprising a continuous transition metal oxide phase permeated by a plurality of pores. The average characteristic dimension of the plurality of pores can, for example, be from 1 nm to 30 nm.

The transition metal oxide can comprise, for example, a metal selected from the group consisting of Ti, V, Cr, Mn, Fe, Co, Ni, Cu, Zr, Nb, Mo, Tc, Ru, Rh, Pd, Ag, Hf, Ta, W, Re, Os, Ir, Pt, Au, La, Ce, Pr, Nd, Pm, Sm, Eu, Gd, Tb, Dy, Ho, Er, Tm, Yb, and combinations thereof. In some embodiments, the transition metal oxide can comprise a catalytically active metal oxide. In some embodiments, the transition metal oxide can comprise a mixed metal oxide. In some embodiments, the transition metal oxide can be selected from the group consisting of ZnMn₂O₄, ZnCo₂O₄, NiCo₂O₄, CoFe₂O₄, Mn₂O₃, Co₃O₄, NiO, and combinations thereof.

Characteristics of the 2D nanosheets, including chemical composition, thickness, aspect ratio, surface area, pore size (e.g., average characteristic dimension of the plurality of pores), and surface porosity, can be varied in view of the desired application for the 2D nanosheet. In some embodiments, the thickness of the 2D nanosheet can be 50 nm or less. In some embodiments, the 2D nanosheet can have an aspect ratio of 10:1 or more. The surface area of the 2D nanosheet can, in some embodiments, be 20 m²/g or more. The 2D nanosheets described herein can, for example, have a surface porosity of 10% or more. The 2D nanosheets described herein can, in some examples, be substantially free of carbon.

Also disclosed herein are methods of making the 2D nanosheets described herein. The 2D nanosheets can be prepared by reacting a graphene template with a transition metal compound to form a nanosheet precursor and calcining the nanosheet precursor to form the 2D nanosheet.

Reacting the graphene template with the transition metal compound can, in some embodiments, comprise contacting the graphene template with the transition metal compound and reducing the transition metal compound. Reducing the transition metal compound can comprise, for example, heating the transition metal compound, contacting the transition metal compound with a reducing agent, or a combination thereof.

Reacting the transition metal compound with the graphene template can, in some embodiments, comprise depositing a transition metal oxide onto the graphene template. As such, in some embodiments, the nanosheet precursor can comprise a transition metal oxide-graphene hybrid material.

Calcining the nanosheet precursor can, for example, comprise heating the nanosheet precursor at a temperature at which the graphene template decomposes, thereby forming the 2D nanosheet. In some embodiments, calcining the nanosheet precursor can comprise heating the nanosheet precursor at a temperature of 400° C. or more.

The 2D nanosheets described herein can be used in applications including, but not limited to, catalysis, sensors, electronics, optoelectronics, energy conversion (e.g., fuel cells, thermoelectrics, solar cells, etc.), and energy storage (e.g., batteries, supercapacitors, etc.).

In some embodiments, the 2D nanosheets described herein can be used as electrodes. In other words, also disclosed herein are electrodes comprising the 2D nanosheets described herein. The electrode can, for example, have a larger specific capacity than that of graphite under the same conditions. In some embodiments, the electrode can have a specific capacity of 250 mA h g⁻¹ or more at a current density of 1000 mA g⁻¹ over 1000 charge/discharge cycles. The electrodes described herein can, for example, have a capacity retention of 85% or more after 1000 charge/discharge cycles. In some embodiments, the electrode can have a Coulombic efficiency of 99% or more over 1000 charge/discharge cycles.

Also disclosed herein are batteries comprising a first electrode comprising a 2D nanosheet described herein, a second electrode, and an electrolyte electrochemically connecting the first electrode and the second electrode. In some embodiments, the battery can further comprise a separator disposed between the first electrode and the second electrode. In some embodiments, the electrolyte can comprise a Li⁺ electrolyte, a Mg⁺ electrolyte, a Na⁺ electrolyte, or combinations thereof. In some embodiments, the electrolyte can comprise a Li⁺ electrolyte.

### DESCRIPTION OF FIGURES

FIG. 1 displays a schematic illustration of the general synthesis of 2D holey transition metal oxide nanosheets.

FIG. 2 displays (a) a scanning transmission electron microscopy (STEM) image of a ZnMn₂O₄ precursors/reduced graphene oxide sample. The inset displays an enlarged STEM image of the ZnMn₂O₄ precursors/reduced graphene oxide sample. (b) The X-ray powder diffraction (XRD) patterns of a reduced graphene oxide (rGO) and ZnMn₂O₄ precursors/reduced graphene oxide sample (ZMO pre/rGO). (c) A high magnification STEM image and the (d) corresponding elemental mapping of a ZnMn₂O₄ precursors/reduced graphene oxide sample. Scale bars are 50 nm (a), 200 nm (inset of a), and 100 nm (c).

FIG. 3 displays the (a) XRD pattern of 2D holey ZnMn₂O₄ nanosheets, indicating the conversion of the precursor compound into spinel ZnMn₂O₄ (JCPDS card No. 24-1133). Inset: Crystal structure of spinel ZnMn₂O₄. (b) TG analysis of reduced graphene oxide (rGO) and 2D holey ZnMn₂O₄ nanosheets (holey ZMO nanosheet). (c) STEM image and (d) corresponding elemental mapping of 2D holey ZnMn₂O₄ nanosheets. (e) HRTEM image of 2D holey ZnMn₂O₄ nanosheets. (f) AFM image and thickness analysis of 2D holey ZnMn₂O₄ nanosheets. Scale bars, 200 nm (c), 2 nm (e).

FIG. 4 displays (a) STEM, (b) enlarged STEM, (c) high-magnification TEM images and (inset of c) the corresponding SAED pattern of 2D holey ZnMn₂O₄ nanosheets prepared at a post-calcination temperature of 400° C. STEM images of 2D holey ZnMn₂O₄ nanosheets prepared at a post-calcination temperature (d) 500° C. and (e) 600° C. (f) Hole size distributions obtained by statistical analysis of the STEM images shown in (a), (d), and (e). Scale bars, 200 nm (a, b, d, e) and 10 nm (c).

FIG. 5 displays (a) the XRD patterns of a free ZnMn₂O₄ sample synthesized without the addition of graphene oxide. (b) SEM image of the free ZnMn₂O₄ sample. (c) Enlarged SEM and (d) corresponding STEM images of the free ZnMn₂O₄ sample. Scale bars, 500 nm (b), 100 nm (c, d).

FIG. 6 displays low magnification SEM images of 2D holey ZnMn₂O₄ nanosheets prepared at (a) 500° C. and (b) 600° C. Scale bars, 1 μm (a, b).

FIG. 7 displays (a, d, g) SEM, (b, e, h) STEM, and (c, f, i) high-magnification TEM images and (insets of c, f, i) corresponding SAED patterns of 2D holey nanosheets of ZnCo₂O₄ (a-c), NiCo₂O₄ (d-f), and CoFe₂O₄ (g-i). Scale bars, 500 nm (a, d, g), 100 nm (b, e, h), and 10 nm (c, f, i).

FIG. 8 displays the XRD patterns of 2D holey nanosheets of (a) ZnCo₂O₄, (b) NiCo₂O₄, and (c) CoFe₂O₄.

FIG. 9 displays the (a-c) XRD patterns, (d-f) SEM images and (g-i) STEM images of 2D holey nanosheets of Mn₂O₃ (a, d, g), Co₃O₄ (b, e, h), and NiO (c, f, i). Scale bars, 200 nm (d-i).

FIG. 10 displays (a) the charge and discharge curves of 2D holey ZnMn₂O₄ nanosheets for the first two cycles at a current density of 200 mA g⁻¹. (b) Representative charge and discharge curves of 2D holey ZnMn₂O₄ nanosheets at various current densities (200, 400, 600, 800, 1000, and 1200 mA g⁻¹).

FIG. 11 displays (a) the cycling performances of 2D holey ZnMn₂O₄ nanosheets (holey ZMO nanosheet, 2^{nd} trace from top), control ZnMn₂O₄+SP (control ZMO+SP, 3^{rd} trace from top), and control ZnMn₂O₄ (control ZMO, bottom trace) samples at a current density of 800 mA g⁻¹ for 50 cycles correspond to the left axis. The coloumbic efficiency of the 2D holey ZnMn₂O₄ nanosheets is shown in the top trace and corresponds to the right axis. (b) Rate performances of 2D holey ZnMn₂O₄ nanosheets (holey ZMO nanosheet, top trace), control ZnMn₂O₄+SP (control ZMO+SP, middle trace), and control ZnMn₂O₄ (control ZMO, bottom trace) samples at different current densities from 200 to 1200 mA g⁻¹. (c) Long-term cycling stability (bottom trace, left axis) and Coulombic efficiency (top trace, right axis) of a 2D holey ZnMn₂O₄ nanosheet sample at a current density of 1000 mA g⁻¹ over 1,000 cycles.

FIG. 12 displays the rate performances of 2D holey ZnMn₂O₄ nanosheet samples prepared at 400° C. (2D holey ZMO-400, top trace), 500° C. (2D holey ZMO-500, middle trace), and 600° C. (2D holey ZMO-600, bottom trace).

FIG. 13 displays the long-term cycling stability (bottom trace in each panel, left axis in each panel) and Coulombic efficiency (top trace in each panel, right axis in each panel) of anodes for lithium-ion batteries prepared from 2D holey mixed transition metal oxide nanosheets of (a) ZnCo₂O₄, (b) NiCo₂O₄, and (c) CoFe₂O₄ at a current density of 1000 mA g⁻¹ over 1000 cycles.

FIG. 14 displays (a) the charge and discharge curves of 2D holey Co₃O₄ nanosheets for the first two cycles at a current density of 100 mA g⁻¹; and (b) representative charge and discharge curves of 2D holey Co₃O₄ nanosheets at various current densities (100 mA g⁻¹, 200 mA g⁻¹, 400 mA g⁻¹, 800 mA g⁻¹, and 1600 mA g⁻¹).

FIG. 15 displays the cycling performance of the 2D holey Co₃O₄ nanosheets (middle trace, left axis) and the control of Co₃O₄ nanoplates without porosity (bottom trace, right axis) at a current density of 800 mA g⁻¹. The coloumbic efficiency of the 2D holey Co₃O₄ nanosheets is shown in the top trace and corresponds to the right axis

FIG. 16 displays a schematic illustration of diffusion of Li⁺ ions through the nanoholes, and continuous transportation of electrons along the interconnected nanocrystals of the 2D holey nanosheets.

FIG. 17 displays an STEM image of a 2D holey ZnMn₂O₄ nanosheet sample after 100 cycles.

### DETAILED DESCRIPTION

The materials, methods and devices described herein may be understood more readily by reference to the following detailed description of specific aspects of the disclosed subject matter, figures and the examples included therein.

Before the present materials, devices and methods are disclosed and described, it is to be understood that the aspects described below are not intended to be limited in scope by the specific devices and methods described herein, which are intended as illustrations. Various modifications of the materials, devices and methods in addition to those shown and described herein are intended to fall within the scope of that described herein. Further, while only certain representative materials, devices and method steps disclosed herein are specifically described, other combinations of the materials, devices and method steps also are intended to fall within the scope of that described herein, even if not specifically recited. Thus, a combination of steps, elements, components, or constituents may be explicitly mentioned herein, however, other combinations of steps, elements, components, and constituents are included, even though not explicitly stated.

### GENERAL DEFINITIONS

“Phase,” as used herein, generally refers to a region of a material having a substantially uniform composition which is a distinct and physically separate portion of a heterogeneous system. The term “phase” does not imply that the material making up a phase is a chemically pure substance, but merely that the chemical and/or physical properties of the material making up the phase are essentially uniform throughout the material, and that these chemical and/or physical properties differ significantly from the chemical and/or physical properties of another phase within the material. Examples of physical properties include density, thickness, aspect ratio, specific surface area, porosity and dimensionality. Examples of chemical properties include chemical composition.

“Continuous,” as used herein, generally refers to a phase such that all points within the phase are directly connected, so that for any two points within a continuous phase, there exists a path which connects the two points without leaving the phase.

The term “two-dimensional nanosheet” or 2D nanosheet, as used herein, refers to a material that has an ultrathin thickness of 50 nm or less, and lateral dimensions (e.g., a length and a width) that are each larger than the thickness of the material, such that the nanosheet has an aspect ratio of 10:1 or more. The term “aspect ratio,” as used herein, refers to the ratio of the shortest lateral dimension of the nanosheet to its thickness.

The term “characteristic dimension,” as used herein, refers to the largest cross-sectional dimension of a pore in a plane perpendicular to the longitudinal axis of the pore. The longitudinal axis of the pore refers to the axis of a pore extending from a first face of the 2D nanosheet into the 2D nanosheet towards or to the second face of the 2D nanosheet. For example, in the case of a substantially cylindrical pore formed in the 2D nanosheet, the characteristic dimension of the pore would be the diameter of the pore.

The characteristic dimension of a pore can be determined, for example, using electron microscopy (e.g., scanning electron microscopy (SEM), transmission electron microscopy (TEM), high-resolution TEM (HRTEM), scanning transmission electron microscopy (STEM)), Brunauer-Emmett-Teller (BET) measurements, or a combination thereof.

The term “graphene,” as used herein, refers to materials that include from one to several atomic monolayers of sp²-bonded carbon atoms. Graphene can have a thickness of from about 1 to about 100 carbon layers (e.g., from about 1 to about 80 graphene layers, from about 1 to about 60 graphene layers, from about 1 to about 40 graphene layers, or from about 1 to about 20 graphene layers). The graphene can have an average thickness, for example, of from about 0.3 nm to about 55 nm (e.g., from about 0.3 nm to about 50 nm, from about 0.3 nm to about 45 nm, from about 0.3 nm to about 40 nm, from about 0.3 nm to about 35 nm, from about 0.3 nm to about 30 nm, from about 0.3 nm to about 25 nm, from about 0.3 nm to about 20 nm, from about 0.3 nm to about 15 nm, from about 0.3 nm to about 10 nm, or from about 0.3 nm to about 5 nm). The term “graphene,” as used herein can thus include a wide range of graphene-based materials including, for example, graphene oxide, graphite oxide, chemically converted graphene, functionalized graphene, functionalized graphene oxide, functionalized graphite oxide, functionalized chemically convened graphene, and combinations thereof.

The term “comprising” and variations thereof as used herein is used synonymously with the term “including” and variations thereof and are open, non-limiting terms. Although the terms “comprising” and “including” have been used herein to describe various examples, the terms “consisting essentially of” and “consisting of” can be used in place of “comprising” and “including” to provide for more specific examples of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

Two-Dimensional Nanosheets

Disclosed herein are two-dimensional (2D) nanosheets comprising a continuous transition metal oxide phase permeated by a plurality of pores.

The 2D nanosheets can be described as porous. The term “porous,” as used herein, refers to materials that include openings and spacings (e.g., pores) which are present as a surface characteristic or a bulk material property, partially or completely penetrating the material. As such, the 2D nanosheets can possess a plurality of pores, voids, holes and/or channels, each of which may or may not extend through the entire thickness of the 2D nanosheet.

The 2D nanosheets comprise a plurality of pores. The average characteristic dimension of the plurality of pores can, for example, be 30 nm or less (e.g., 28 nm or less, 26 nm or less, 24 nm or less, 22 nm or less, 20 nm or less, 18 nm or less, 16 nm or less, 14 nm or less, 12 nm or less, 10 nm or less, 8 nm or less, 6 nm or less, 4 nm or less, or 2 nm or less). In some embodiments, the average characteristic dimension of the plurality of pores can be 1 nm or more (e.g., 2 nm or more, 4 nm or more, 6 nm or more, 8 nm or more, 10 nm or more, 12 nm or more, 14 nm or more, 16 nm or more, 18 nm or more, 20 nm or more, 22 nm or more, 24 nm or more, 26 nm or more, or 28 nm or more).

The average characteristic dimension of the plurality of pores can range from any of the minimum values described above to any of the maximum values described above, for example from 1 nm to 30 nm (e.g., from 1 nm to 16 nm, from 16 nm to 30 nm, from 1 nm to 10 nm, from 10 nm to 20 nm, from 20 nm to 30 nm, from 4 nm to 20 nm, from 4 nm to 10 nm, from 6 nm to 12 nm, or from 14 nm to 20 nm).

The plurality of pores can, in some examples, have a substantially constant characteristic dimension along their length. In some embodiments, the characteristic dimension of the plurality of pores is substantially constant from pore to pore throughout the 2D nanosheet, such that substantially all (e.g., 75% or more, 80% or more, 85% or more, 90% or more, or 95% or more) of the pores in the 2D nanosheet have a characteristic dimension that is within 40% of the average characteristic dimension of the plurality of pores (e.g., within 35% of the average characteristic dimension of the plurality of pores, within 30% of the average characteristic dimension of the plurality of pores, within 25% of the average characteristic dimension of the plurality of pores, within 20% of the average characteristic dimension of the plurality of pores, within 15% of the average characteristic dimension of the plurality of pores, or within 10% of the average characteristic dimension of the plurality of pores).

The walls of the plurality of pores are formed from the continuous transition metal oxide phase. The transition metal oxide can comprise, for example, a metal selected from the group consisting of Ti, V, Cr, Mn, Fe, Co, Ni, Cu, Zr, Nb, Mo, Tc, Ru, Rh, Pd, Ag, Hf, Ta, W, Re, Os, Ir, Pt, Au, La, Ce, Pr, Nd, Pm, Sm, Eu, Gd, Tb, Dy, Ho, Er, Tm, Yb, and combinations thereof. In certain embodiments, the transition metal oxide can comprise a metal selected from the group consisting of Zn, Mn, Co, Ni, Fe, and combinations thereof

In some embodiments, the transition metal oxide can comprise a catalytically active metal oxide. In some embodiments, the transition metal oxide can comprise a mixed metal oxide. In some embodiments, the transition metal oxide can comprise a transition metal oxide selected from the group consisting of ZnMn₂O₄, ZnCo₂O₄, NiCo₂O₄, CoFe₂O₄, Mn₂O₃, Co₃O₄, NiO, and combinations thereof. The nature of the transition metal oxide can be determined, for example, using X-Ray powder diffraction (XRD), selected area electron diffraction (SAED), elemental analysis, or a combination thereof.

The amount of organic carbon present in a 2D nanosheet can be estimated by measuring the material's loss-on-ignition (LOI). The LOI of a filler refers to the percent weight loss of a sample of the 2D nanosheet upon ignition at 750° C. for 2 hours, and then further heating at 750° C. to a constant mass to consume any organic carbon present in the 2D nanosheet, as described, for example in ASTM C618-12a.

In some embodiments, the 2D nanosheet can have an LOI of less than 10% (e.g., less than 9.75, less than 9.5%, less than 9.25%, less than 9.0%, less than 8.75, less than 8.5%, less than 8.25%, less than 8.0%, less than 7.75, less than 7.5%, less than 7.25%, less than 7.0%, less than 6.75%, less than 6.5%, less than 6.25%, less than 6.0%, less than 5.75%, less than 5.5%, less than 5.25%, less than 5.0%, less than 4.75%, less than 4.5%, less than 4.25%, less than 4.0%, less than 3.75%, less than 3.5%, less than 3.25%, less than 3.0%, less than 2.75%, less than 2.5%, less than 2.25%, less than 2.0%, less than 1.9%, less than 1.8%, less than 1.7%, less than 1.6%, less than 1.5%, less than 1.4%, less than 1.3%, less than 1.2%, less than 1.1%, less than 1.0%, less than 0.95%, less than 0.90%, less than 0.85%, less than 0.80%, less than 0.75%, less than 0.70%, less than 0.65%, less than 0.60%, or less than 0.55%). In certain embodiments, the 2D nanosheets described herein can be substantially free of carbon (i.e., the 2D nanosheet can have an LOI of less than 0.50%).

Characteristics of the 2D nanosheets, including thickness, aspect ratio, surface area, pore size (e.g., average characteristic dimension of the plurality of pores), and surface porosity, can be varied in view of the desired application for the 2D nanosheet.

In some embodiments, the thickness of the 2D nanosheet can be 50 nm or less (e.g., 45 nm or less, 40 nm or less, 35 nm or less, 30 nm or less, 25 nm or less, 20 nm or less, 15 nm or less, or 10 nm or less). In some embodiments, the thickness of the 2D nanosheet can be 5 nm or more (e.g., 10 nm or more, 15 nm or more, 20 nm or more, 25 nm or more, 30 nm or more, 35 nm or more, 40 nm or more, or 45 nm or more).

The 2D nanosheet can have a thickness ranging from any of the minimum values described above to any of the maximum values described above. For example, the 2D nanosheet can have a thickness of from 5 nm to 50 nm (e.g., from 5 nm to 30 nm, from 30 nm to 50 nm, from 5 nm to 15 nm, from 15 nm to 30 nm, from 30 nm to 40 nm, or from 40 nm to 50 nm). The thickness of the 2D nanosheet can be determined, for example, via atomic force microscopy (AFM).

The thickness of the 2D nanosheet can be varied based on the intended application for the 2D nanosheet. In some applications (e.g., for use as a catalyst), a thinner 2D nanosheet (e.g., a 2D nanosheet having a thickness of from 5 nm to 15 nm) can be desirable. For other applications (e.g., for use as an electrode in a battery) a thinner 2D nanosheet (e.g., a 2D nanosheet having a thickness of from 5 nm to 15 nm) can be desirable.

In some embodiments, the 2D nanosheet can have an aspect ratio of 10:1 or more (e.g., 15:1 or more, 20:1 or more, 25:1 or more, 30:1 or more, 35:1 or more, 40:1 or more, 45:1 or more, 50:1 or more, 60:1 or more, 70:1 or more, 80:1 or more, 90:1 or more, 100:1 or more, 150:1 or more, 200:1 or more, 250:1 or more, 300:1 or more, 350:1 or more, 400:1 or more, 450:1 or more, 500:1 or more, 600:1 or more, 700:1 or more, 800:1 or more, or 900:1 or more). In some embodiments, the 2D nanosheet can have an aspect ratio of 1000:1 or less (e.g., 900:1 or less, 800:1 or less, 700:1 or less, 600:1 or less, 500:1 or less, 450:1 or less, 400:1 or less, 350:1 or less, 300:1 or less, 250:1 or less, 200:1 or less, 150:1 or less, 100:1 or less, 90:1 or less, 80:1 or less, 70:1 or less, 60:1 or less, 50:1 or less, 45:1 or less, 40:1 or less, 35:1 or less, 30:1 or less, 25:1 or less, 20:1 or less, or 15:1 or less).

The 2D nanosheet can have an aspect ratio ranging from any of the minimum values described above to any of the maximum values described above. For example, the 2D nanosheet can have an aspect ratio of from 10:1 to 1000:1 (e.g., from 10:1 to 500:1, from 500:1 to 1000:1, from 10:1 to 250:1, from 250:1 to 500:1, or from 20:1 to 100:1).

The surface area of the 2D nanosheet can, in some embodiments, be 20 m²/g or more (e.g., 25 m²/g or more, 50 m²/g or more, 75 m²/g or more, 100 m²/g or more, 125 m²/g or more, 150 m²/g or more, or 175 m²/g or more). In some embodiments, the surface area of the 2D nanosheet can be 200 m²/g or less (e.g., 175 m²/g or less, 150 m²/g or less, 125 m²/g or less, 100 m²/g or less, 75 m²/g or less, 50 m²/g or less, or 25 m²/g or less).

The 2D nanosheet can have a surface area ranging from any of the minimum values described above to any of the maximum values described above. For example, the 2D nanosheet can have a surface area of from 20 m²/g to 200 m²/g (e.g., from 20 m²/g to 100 m²/g, from 100 m²/g to 200 m²/g, or from 50 m²/g to 175 m²/g). The surface area of the 2D nanosheets described herein can be determined by any suitable method, such as the Brunauer-Emmett-Teller (BET) method.

The 2D nanosheets described herein can, for example, have a surface porosity of 10% to 50%. The term “surface porosity,” as used herein, refers to the percentage of a surface of the 2D nanosheet that comprises pores. For example, the surface porosity of a 2D nanosheet can be determined by capturing an image of the 2D nanosheet (e.g., by electron microscopy), and determining the percent of the surface area of the 2D nanosheet that comprises pores (i.e., the surface porosity) from that image

The 2D nanosheet can, in some embodiments, have a surface porosity of 10% or more (e.g., 15% or more, 20% or more, 25% or more, 30% or more, 35% or more, 40% or more, or 45% or more). In some embodiments, the 2D nanosheet can have a surface porosity of 50% or less (e.g., 45% or less, 40% or less, 35% or less, 30% or less, 25% or less, 20% or less, or 15% or less).

The 2D nanosheet can have a surface porosity ranging from any of the minimum values described above to any of the maximum values described above. For example, the 2D nanosheet can have a surface porosity of from 10% to 50% (e.g., from 10% to 30%, from 30% to 50%, from 10% to 20%, from 20% to 30%, from 30% to 40%, from 40% to 50%, from 15% to 45%, or from 20% to 40%).

Methods of Making

Also disclosed herein are methods of making the 2D nanosheets described herein. The 2D nanosheets can be prepared by (i) reacting a graphene template with a transition metal compound to form a nanosheet precursor, and (ii) calcining the nanosheet precursor to form the 2D nanosheet.

Any suitable graphene template can be used. For example the graphene template can comprise synthetic graphene, natural graphene, or combinations thereof. The graphene template can, for example, comprise graphene flakes, graphene sheets, graphene ribbons, graphene particles, or combinations thereof. Suitable graphene templates are known in the art, and can be obtained commercially or prepared according to known methods.

A ready source of graphene is bulk graphite, which consists of a large number of graphene sheets held together through van der Waals forces. Single- and few-layer graphene sheets have been prepared in microscopic quantities by mechanical exfoliation of bulk graphite (commonly referred to as the “Scotch-tape” method) and by epitaxial chemical vapor deposition.

To date, methods for preparing bulk quantities of graphene have centered on chemical exfoliation of graphite. The most common approach for exfoliation of graphite has been to use a strong oxidizing agent to produce graphene oxide, a non-conductive and hydrophilic carbon material. Although the exact chemical structure of graphene oxide is difficult to conclusively determine, it is at least qualitatively evident that the regular sp² structure is disrupted in graphene oxide with epoxides, alcohols, carbonyls and carboxylic acid groups. The disruption of the lattice in bulk graphite is reflected in an increase in interlayer spacing from 0.335 nm in bulk graphite to more than 0.625 nm in graphene oxide.

Graphene oxide was first prepared in 1859 by adding potassium chlorate to a slurry of graphite in fuming nitric acid. The synthesis was improved in 1898 by including sulfuric acid in the reaction mixture and adding the potassium chlorate portionwise over the course of the reaction. The most common method used today is that reported by Hummers in which bulk graphite is oxidized by treatment with KMnO₄ and NaNO₃ in concentrated H₂SO₄ (Hummers' method).

In some embodiments, the graphene template can comprise graphene oxide. In certain embodiments, the graphene template can comprise graphene oxide prepared by Hummers' method.

The transition metal compound can comprise any compound comprising a transition metal. In some embodiments, the transition metal compound can comprise a metal selected from the group consisting of Ti, V, Cr, Mn, Fe, Co, Ni, Cu, Zr, Nb, Mo, Tc, Ru, Rh, Pd, Ag, Hf, Ta, W, Re, Os, Ir, Pt, Au, La, Ce, Pr, Nd, Pm, Sm, Eu, Gd, Tb, Dy, Ho, Er, Tm, Yb, and combinations thereof. In some embodiments, the transition metal compound can comprise a transition metal salt. The counterion of the transition metal salt can be, for example, a nitrate, phosphate, acetate, sulfate, or chloride. Other suitable counterions include organic or inorganic ions, such as carbonate, bromide, iodide, sulfite, phosphite, nitrite, and combinations thereof. In some embodiments, the transition metal compound can comprise a transition metal acetate. The transition metal compounds suitable for use herein can be readily obtained from commercial suppliers or synthesized by methods known in the art.

Reacting the graphene template with the transition metal compound can, in some embodiments, comprise contacting the graphene template with the transition metal compound and reducing the transition metal compound. Contacting the graphene template with the transition metal compound can be performed by, for example, adding the graphene template to the transition metal compound or by adding the transition metal compound to the graphene template. Contacting can also be performed by slowing mixing one component with the other or by drop-wise addition of one component into the other. Agitation (e.g., stirring, shaking, or ultrasonic agitation) can be used to facilitate the contacting of the graphene template with the transition metal compound. Reducing the transition metal compound can comprise, for example, heating the transition metal compound, contacting the transition metal compound with a reducing agent, or a combination thereof.

In some embodiments, reacting the graphene template with the transition metal compound can comprise contacting the transition metal compound with a reducing agent. The reducing agent can be added to the mixture by any method known in the art or described herein. Suitable reducing agents include, but are not limited to, hydrogen gas, alcohols (e.g., methanol, ethanol), polyols, polyethers (e.g., ethylene glycol), carboxylic acids (e.g., acetic acid), aldehydes, hydrazines, hydrides, ketones, boranes, and the like, and combinations thereof. In some examples, the reducing agent is ethylene glycol.

In some embodiments, reacting the graphene template with the transition metal compound can comprise heating. In some embodiments, reacting the graphene template with the transition metal compound can comprise heating at a temperature of 200° C. or more (e.g., 225° C. or more, 250° C. or more, 275° C. or more, 300° C. or more, 325° C. or more, 350° C. or more, or 375° C. or more). In some embodiments, reacting the graphene template with the transition metal compound can comprise heating at a temperature of 400° C. or less (e.g., 375° C. or less, 350° C. or less, 325° C. or less, 300° C. or less, 275° C. or less, 250° C. or less, or 225° C. or less). The temperature at which the graphene template reacts with the transition metal compound can range from any of the minimum values described above to any of the maximum values described above. For example, in some embodiments, reacting the graphene template with the transition metal compound can comprise heating at a temperature of from 200° C. to 400° C. (e.g., from 200° C. to 300° C., from 300° C. to 400° C., from 200° C. to 250° C., from 250° C. to 300° C., from 300° C. to 350° C. from 350° C. to 400° C., or from 250° C. to 350° C.).

Reacting the transition metal compound with the graphene template can, in some embodiments, comprise depositing a transition metal oxide onto the graphene template. As such, in some embodiments, the nanosheet precursor can comprise a transition metal oxide-graphene hybrid material (e.g., a transition metal oxide deposited on the graphene template).

Calcining the nanosheet precursor can, for example, comprise heating the nanosheet precursor at a temperature at which the graphene template decomposes, thereby forming the 2D nanosheet. The decomposition of the graphene template can be determined, for example, using thermogravimetric (TG) analysis.

In some embodiments, calcining the nanosheet precursor can comprise heating the nanosheet precursor at a temperature of 400° C. or more (e.g., 425° C. or more, 450° C. or more, 475° C. or more, 500° C. or more, 525° C. or more, 550° C. or more, or 575° C. or more). In some embodiments, calcining the nanosheet precursor can comprise heating the nanosheet precursor at a temperature of 600° C. or less (e.g., 575° C. or less, 550° C. or less, 525° C. or less, 500° C. or less, 475° C. or less, 450° C. or less, or 425° C. or less). The temperature at which the nanosheet precursor is calcined can range from any of the minimum values described above to any of the maximum values described above. For example, in some embodiments, calcining the nanosheet precursor can comprise heating the nanosheet precursor at a temperature of from 400° C. to 600° C. (e.g., from 400° C. to 500° C., from 500° C. to 600° C., from 400° C. to 450° C. from 450° C. to 500° C., from 500° C. to 550° C., from 550° C. to 600° C., or from 450° C. to 550° C.).

Applications

The 2D nanosheets described herein can be used in applications including, but not limited to, catalysis, sensors, electronics, optoelectronics, energy conversion (e.g., fuel cells, thermoelectrics, solar cells, etc.), and energy storage (e.g., batteries, supercapacitors, etc.).

The utility of the 2D nanosheets for a particular application will depend on several factors, including the nature of the continuous transition metal oxide phase, as well as the morphology of the 2D nanosheet. Appropriate 2D nanosheets for a particular application can be selected in view of the type of application.

In some embodiments, the 2D nanosheets described herein can be used as electrodes. The electrode can, for example, have a larger specific capacity than that of graphite under the same conditions. In some embodiments, the electrode can have a specific capacity of 250 mA h g⁻¹ or more at a current density of 1000 mA g⁻¹ over 1000 charge/discharge cycles (e.g., 300 mA h g⁻¹ or more, 350 mA h g⁻¹ or more, 400 mA h g⁻¹ or more, 450 mA h g⁻¹ or more, 500 mA h g⁻¹ or more, 550 mA h g⁻¹ or more, 600 mA h g⁻¹ or more, 650 mA h g⁻¹ or more, 700 mA h g⁻¹ or more, 750 mA h g⁻¹ or more, 800 mA h g⁻¹ or more, 850 mA h g⁻¹ or more, 900 mA h g⁻¹ or more, or 950 mA h g⁻¹ or more). In some embodiments, the electrode can have a specific capacity of 1000 mA h g⁻¹ or less at a current density of 1000 mA g⁻¹ over 1000 charge/discharge cycles (e.g., 950 mA h g⁻¹ or less, 900 mA h g⁻¹ or less, 850 mA h g⁻¹ or less, 800 mA h g⁻¹ or less, 750 mA h g⁻¹ or less, 700 mA h g⁻¹ or less, 650 mA h g⁻¹ or less, 600 mA h g⁻¹ or less, 550 mA h g⁻¹ or less, 500 mA h g⁻¹ or less, 450 mA h g⁻¹ or less, 400 mA h g⁻¹ or less, 350 mA h g⁻¹ or less, or 300 mA h g⁻¹ or less).

The specific capacity of the electrode can range from any of the minimum values described above to any of the maximum values described above. For example, the electrode can have a specific capacity of from 250 mA h g⁻¹ to 1000 mA h g⁻¹ at a current density of 1000 mA g⁻¹ over 1000 charge/discharge cycles (e.g., from 250 mA h g⁻¹ to 650 mA h g⁻¹, from 650 mA h g⁻¹ to 1000 mA h g⁻¹, from 250 mA h g⁻¹ to 750 mA h g⁻¹, from 500 mA h g⁻¹ to 1000 mA h g⁻¹, from 250 mA h g⁻¹ to 500 mA h g⁻¹, from 500 mA h g⁻¹ to 750 mA h g⁻¹, from 750 mA h g⁻¹ to 1000 mA h g⁻¹, or from 450 mA h g⁻¹ to 800 mA h g⁻¹).

The electrodes described herein can, for example, retain most of their specific capacity after several charge/discharge cycles. For example, in some embodiments, the electrode can have a capacity retention of 85% or more after 1000 charge/discharge cycles (e.g., 86% or more, 87% or more, 88% or more, 89% or more, 90% or more, 91% or more, 92% or more, 93% or more, or 94%0 or more). In some embodiments, the electrode can have a capacity retention of 95% or less after 1000 charge/discharge cycles (e.g., 94% or less, 93% or less, 92% or less, 91% or less, 90% or less, 89% or less, 88% or less, 87% or less, or 86% or less).

The capacity retention of the electrode can range from any of the minimum values described above to any of the maximum values described above. For example, in some embodiments the capacity retention of the electrode can be from 85% to 95% after 1000 charge/discharge cycles (e.g., from 85% to 90%, from 90% to 95%, or from 88% to 92%).

The electrodes described herein can, in some embodiments, have a high Coulombic efficiency. For example, in some embodiments, the electrode can have a Coulombic efficiency of 99% or more over 1000 charge/discharge cycles (e.g., 99.1% or more, 99.2% or more, 99.3% or more, 99.4% or more, 99.5% or more, 99.6% or more, 99.7% or more, 99.8% or more, or 99.9% or more). In some embodiments, the electrode can have a Coulombic efficiency of 100% or less over 1000 charge/discharge cycles (e.g., 99.9% or less, 99.8% or less, 99.7% or less, 99.6% or less, 99.5% or less, 99.4% or less, 99.3% or less, 99.2% or less, or 99.1% or less).

The Coulombic efficiency of the electrode can range from any of the minimum values described above to any of the maximum values described above. For example, in some embodiments the electrode can have a Coulombic efficiency of from 99% to 100% over 1000 charge/discharge cycles (e.g., from 99% to 99.5%, from 99.5% to 100%, from 99% to 99.3%, from 99.3% to 99.6%, from 99.6% to 100%, or from 99.2% to 99.8%).

Also disclosed herein are methods of use of the 2D nanosheets described herein, or the electrodes comprising the 2D nanosheets described herein, in batteries. As such, disclosed herein are batteries comprising a first electrode comprising any of the 2D nanosheets described herein, a second electrode, and an electrolyte in electrochemical connect with the first electrode and the second electrode. Also disclosed herein are methods of use of the 2D nanosheets described herein as electrodes for lithium-ion batteries and for new-generation batteries even beyond lithium-ion, such as sodium ion batteries and magnesium ion batteries.

The electrolyte can comprise any electrolyte consistent with the methods described herein. In some embodiments, the electrolyte can comprise a Li⁺ electrolyte, a Mg⁺ electrolyte, a Na⁺ electrolyte, or combinations thereof. In some embodiments, the electrolyte can comprise a Li⁺ electrolyte.

In some embodiments, the battery can further comprise a separator disposed between the first electrode and the second electrode.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process.

### Example 1

### Overview

Two-dimensional (2D) nanomaterials, such as graphene and transition metal dichalcogenides, can be desirable for many applications but the preparation of 2D transition metal oxide nanostructures can be challenging. Herein, a template-directed self-assembly strategy for synthesis of 2D holey transition metal oxide nanosheets is discussed. This route can be used to generate 2D holey nanosheets of various transition metal oxides, including mixed oxides such as ZnMn₂O₄, ZnCo₂O₄, NiCo₂O₄, and CoFe₂O₄, and simple oxides such as Mn₂O₃, Co₃O₄, and NiO. The synthesis strategy discussed herein can also be used to design 2D holey nanostructures with adjustable hole size. Unlike conventional nanosheets with flat and smooth surfaces, the 2D holey nanosheets possess tunable porosity that can enhance charge/mass transport properties, which can be important for many energy devices. It is shown herein that these 2D holey nanosheet structures can exhibit excellent rate capability and cycling stability when functioning as lithium-ion battery anodes. The approach presented herein can be used to design and synthesize 2D holey nanostructures that can synergize features of both 2D nanostructures and controlled porosity. These types of 2D holey nanostructures can be of interest in a broad range of technological areas from electronics and optoelectronics to energy and environmental technologies.

### INTRODUCTION

Dimensionality can play a role in determining the fundamental properties of nanomaterials (Huang X et al. Adv. Mater. 2014, 26, 2185-2204; Jariwala D et al. Chem. Soc. Rev. 2013, 42, 2824-2860). For example, electrons can interact differently in three-, two-, one- and zero-dimensional nanostructures (Jariwala D et al. Chem. Soc. Rev. 2013, 42, 2824-2860). Recent research on the two-dimensionalization of materials has discussed tuning the fundamental physical and chemical properties of such two-dimensional materials (Huang X et al. Adv. Mater. 2014, 26, 2185-2204). Due to physical and chemical properties, such as quantum confinement and surface effects, two-dimensional (2D) nanosheet materials can show potential in a wide range of applications, such as catalysis, energy storage, and electronics (Huang X et al. Adv. Mater. 2014, 26, 2185-2204). This has been highlighted over the past decade in graphene materials, which can exhibit enhanced properties compared to bulk graphite and other low-dimensional carbon nanostructures (Geim A K and Novoselov K S. Nat. Mater. 2007, 6, 183-191; Zhu Y et al. Adv. Mater. 2010, 22, 3906-3924). Beyond graphene, 2D nanosheets of hexagonal boron nitride (h-BN), metal dichalcogenides (TMDs), and metal phosphates have also been investigated and have exhibited properties that can be distinct from their bulk counterparts (Chhowalla M et al. Nat. Chem. 2013, 5, 263-275; Wang Q H et al. Nat. Nanotechnol. 2012, 7, 699-712; Butler S Z et al. ACS Nano. 2013, 7, 2898-2926: Renzhi M and Takayoshi S. Adv. Mater. 2010, 22, 5082-5104).

Transition metal oxides, including simple transition metal oxides (e.g., with one type of transition metal element) and mixed transition metal oxides (e.g., with different transition metal elements), are a family of materials that can be used in a broad range applications, for example catalysis, energy storage, and energy conversion technologies (Cheng F et al. Nat Chem. 2011, 3, 79-84: Liang Y et al. J. Am. Chem. Soc. 2012, 134, 3517-3523; Xiong P et al. J. Mater. Chem. 2012, 22, 17485-17493: Liang Y et al. Nat. Chem. 2011, 10, 780-786: Jiang J et al. Adv. Mater. 2012, 24, 5166-5180; Yuan C et al. Angew. Chem. Int. Ed 2014, 53, 1488-1504; Xiong P et al. J. Power Sources 2014, 245, 937-946; Xiong P et al. ACS Nano 2014, 8, 8610-8616). Transition metal oxide nanomaterials can be obtained in the form of zero-dimensional (0D) nanoparticles (Zeng H et al. J. Am. Chem. Soc. 2004, 126, 11458-11459: Niederberger M. Acc. Chem. Res. 2007, 40, 793-800), 1D nanotubes or nanowires (Devan R et al. Adv. Funct. Mater. 2012, 22, 3326-3370), and 3D nanoclusters or microspheres (Hu L et al. Sci. Rep. 2012, 2, 986: Nakashima T and Kimizuka N. J. Am. Chem. Soc. 2003, 125, 6386-6387: Jin Z et al. Angew. Chem. Int. Ed. 2012, 51, 6406-6410). In contrast, 2D nanostructures, such as free-standing nanosheets with confined thickness, are less common in transition metal oxide material systems.

General methods that can be used to prepare 2D nanomaterials include mechanical exfoliation (Novoselov K S et al. Proc. Natl. Acad. Sci. USA 2005, 102, 10451-10453; Yin Z et al. ACS Nano 2011, 6, 74-80) and direct liquid exfoliation (Coleman J N et al. Science 2011, 331, 568-571: Zhou K G et al. Angew. Chem. Int. Ed. 2011, 50, 10839-10842) of their layered crystals. The bulk material forms of graphene, TMDs, and h-BN are layered structures with strong covalent bonding within each layer and weak van der Waals forces between the layers. Thus, single or few-layer nanosheets of these materials can be obtained via mechanical cleavage or direct ultrasonication in solvents. It has been reported that almost all bulk layered TMD crystals can be exfoliated in common solvents, such as N-methylpyrrolidone (NMP), dimethylformamide (DMF), and isopropyl alcohol (IPA), to give mono- and few-layer nanosheets (Coleman J N et al. Science 2011, 331, 568-571). Unfortunately, based on these top-down synthesis strategies, only a few kinds of 2D nanomaterials (e.g., those possessing a suitably layered crystal matrix) can be obtained (Coleman J N et al. Science 2011, 331, 568-571; Nicolosi V et al. Science 2013, 340, 1226419). Moreover, scalable synthesis can be challenging. Although some simple transition metal oxide nanosheets, such as MnO₂ nanosheets, have been prepared via exfoliation of their layered matrices (Omomo Y et al. J. Am. Chem. Soc. 2003, 125, 3568-3575), most bulk transition metal oxides do not have layered structures and therefore cannot be exfoliated via the general exfoliation method to obtain a 2D nanostructure. Therefore, scalable synthetic strategies for generating transition metal oxide nanosheets for materials with non-layered bulk crystal structures are still needed.

Template-directed strategies can be used to prepare nanomaterials with controllable structure (Liang H W et al. Adv. Mater. 2010, 22, 3925-3937). Recently, self-assembly of transition metal sulfides (Du Y et al. Nat. Commun. 2012, 3, 1177) and oxides (Liu Q et al. Small 2014, 10, 48-51) on laminar templates have been applied to synthesize well-defined 2D features with confined thickness. Graphene oxide, an oxidized 2D carbon sheet, has been used as a template to prepare various graphene-transition metal oxide nanosheets owing to the oxygen-contained active sites on the surface of the graphene oxide (Xiong P et al. ACS Nano 2014, 8, 8610-8616: Huang X et al. Chem. Soc. Rev. 2012, 41, 666-686; Wang H et al. J. Am. Chem. Soc. 2010, 132, 13978-13980; Liang Y et al. Nat. Mater. 2011, 10, 780-786). However, in these previous studies the structures of the graphene oxide substrates remain unchanged, such that the resulting material is a graphene-based composite/hybrid nanosheet, rather than single component 2D nanostructure.

Herein, a general template-directed self-assembly strategy for the synthesis of 2D holey transition metal oxide nanosheets by employing graphene oxide as a sacrificial template is discussed. Graphene oxide was employed as a template to grow various transition metal oxide precursors on its surface. The transition metal oxide precursors were transformed into 2D holey transition metal oxide nanosheets due to the interconnection of the transition metal oxide nanoparticles and the decomposition of the graphene oxide during thermal post-treatment. This strategy was also used to synthesize various 2D holey nanosheets of transition metal oxides, including mixed transition metal oxides (such as ZnMn₂O₄, ZnCo₂O₄, NiCo₂O₄, and CoFe₂O₄), and simple transition metal oxides (such as Mn₂O₃, Co₃O₄, and NiO). In addition, 2D holey nanosheets with adjustable hole size were obtained through control of calcination temperatures. Compared with exfoliation methods, this strategy can extend the 2D nanomaterial family to include 2D nanosheets for those materials not having a layered bulk structure. This strategy can also make scalable synthesis possible. Unlike conventional nanosheets with smooth surfaces and/or porous micro-scaled materials, these resulting 2D holey nanosheets can possess both 2D nanostructure and porosity, which can result in the 2D holey nanosheets exhibiting superior properties compared to conventional nanosheets and/or porous micro-scaled materials. 2D nanosheets can be used in areas ranging from electronics to catalysis (Osada M and Sasaki T. Adv. Mater. 2012, 24, 210-228; Gunjakar J L et al. J. Phys. Chem. C 2014, 118, 3847-3863). For example, 2D nanostructures can potentially bring not only effective electron transport, but also enhanced host capabilities, which can arise from the enlarged surface areas and improved diffusion processes (Seo J W et al. Angew. Chem. Int. Ed. 2007, 46, 8828-8831). 2D nanostructures have also been employed to increase the surface area of total catalysis and improve catalytic activities (Gunjakar J L et al. J. Am. Chem. Soc. 2011, 133, 14998-15007; Shin S I et al. Energy Environ. Sci. 2013, 6, 608-617). Nanomaterials with porosity have been involved in advanced energy storage and conversion systems, owing to their interfacial transport properties, shortened diffusion paths, reduced diffusion effects, and enhanced structure integrity (Li Y et al. Adv. Funct. Mater. 2012, 22, 4634-4667; Ge M et al. Nano Lett. 2013, 14, 261-268).

Experimental

Synthesis of Graphene Oxide.

Graphene oxide was prepared from purified natural graphite by a modified Hummers method. Simply, 10 g of graphite powder was first added to 15 mL of concentrated H₂SO₄. Then, 5 g of K₂S₂O₈ and 5 g of P₂O₅ were slowly added. The as-obtained mixed solution was heated to 80° C. and maintained at this temperature for 6 h. After cooling to room temperature, the resultant mixture was carefully diluted with distilled water, filtered, and washed on the filter until the pH of the rinse water became neutral. The product was dried in air at ambient temperature overnight. The preoxidized graphite was then added to 230 mL of concentrated H₂SO₄ cooled in an ice-water bath. To this mixture, 30 g of KMnO₄ was added very slowly with stirring and cooling. All operations were carried out very slowly in a fume hood. The mixture was then stirred at 35° C. for 30 min. Then, 460 mL of distilled water was slowly added to increase the temperature to 98° C. and the mixture was maintained at that temperature for 15 min. The reaction was terminated by adding 1.4 L of distilled water, followed by 10 mL of 30% H₂O₂ solution. The solid product was separated by centrifugation, washed repeatedly with 5% HCl solution, and then dialyzed for a week.

Synthesis of 2D Holey Transition Metal Oxide Nanosheets.

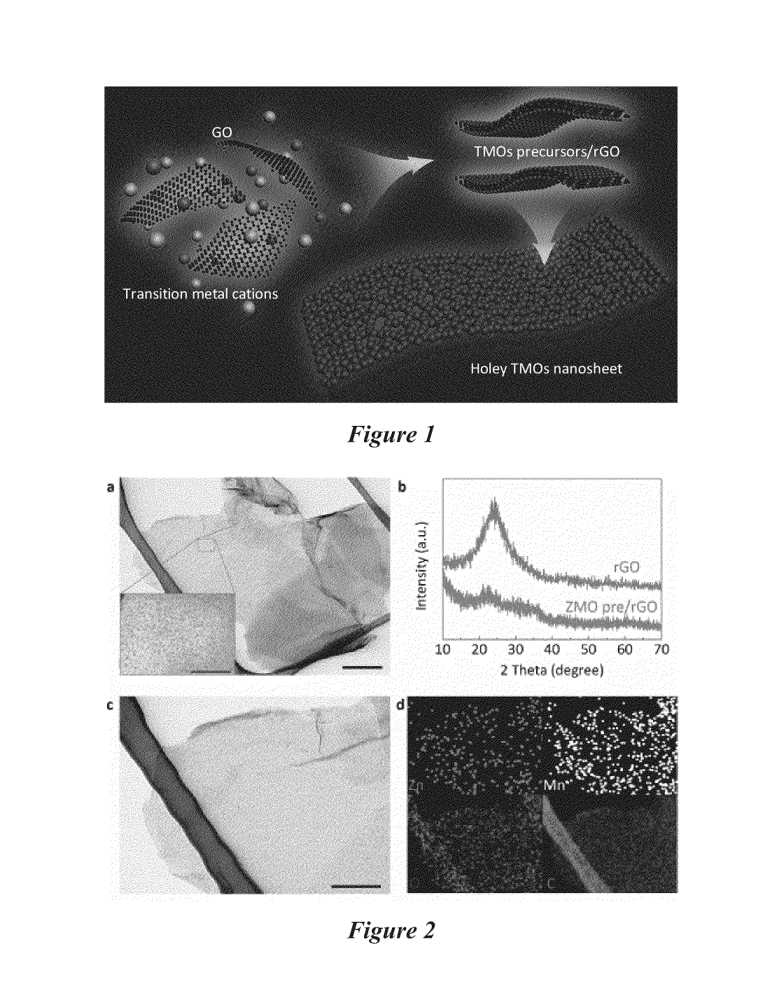

The 2D holey transition metal oxide nanosheets were prepared via a template-directed self-assembly method as illustrated in FIG. 1a. In a typical synthesis of the 2D holey ZnMn₂O₄ nanosheets, 30 mg of graphene oxide powder was dispersed in 100 mL of ethylene glycol and sonicated to form a homogenous suspension. After this, 0.5 mmol of Zn(CH₃COO)₂.2 H₂O and 1.0 mmol of Mn(CH₃COO)₂.4 H₂O were dissolved in the suspension. The obtained suspension was then transferred into a round bottom flask and heated to 170° C. in an oil bath, and stirred at this temperature for 120 min. The mixture was then allowed to cool down to room temperature, and the as-made precipitate was collected by centrifugation and washed with ethanol several times. The product (denoted as ZnMn₂O₄ precursors/graphene oxide) was then dried in vacuo at 80° C. overnight. The ZnMn₂O₄ precursors/graphene oxide was then annealed at 400° C. in air for 120 min with a slow heating rate (0.5° C. min⁻¹) to obtain the 2D holey ZnMn₂O₄ nanosheets. A control ZnMn₂O₄ sample was prepared by combining 0.5 mmol of Zn(CH₃COO)₂.2 H₂O, 1.0 mmol of Mn(CH₃COO)₂.4 H₂O and 100 mL of ethylene glycol without any graphene oxide added according to the method above. Reduced graphene oxide was prepared according to the method above but in the absence of Zn(CH₃COO)₂.2 H₂O and Mn(CH₃COO)₂.4 H₂O. To evaluate the influence of calcination temperature, the as-made ZnMn₂O₄ precursors/graphene oxide were also annealed at 500° C. and 600° C. in air for 120 min with the same heating rate as before (0.5° C. min⁻¹). 2D holey ZnCo₂O₄ and NiCo₂O₄ nanosheets were also prepared with the corresponding two transition metal acetates in the presence of graphene oxide according to the method above. 2D holey CoFe₂O₄ nanosheets were prepared by replacing the Zn(CH₃COO)₂.2 H₂O and Mn(CH₃COO)₂.4 H₂O with Co(NO₃)₂.6 H₂O and Fe(NO₃)₃.9 H₂O according to the method above. 2D holey Mn₂O₃, Co₃O₄, and NiO nanosheets were also prepared with the corresponding single transition metal acetate in the presence of graphene oxide according to the method above.

Characterizations.

The structures of the as-synthesized samples were characterized by powder X-ray diffraction (XRD) performed on a Philips Vertical Scanning diffractometer. The morphology of the samples was investigated using scanning transmission electron microscopy (STEM) (Hitachi $5500), and transmission electron microscopy (TEM) (JEOL 2010F). Thermogravimetric (TG) analysis was performed on a TGA/SDTA851e thermogravimetric analyzer under an air atmosphere from 25° C. to 850° C. at a heating rate of 10° C. min⁻¹. Atomic force microscopy (AFM) (ParkAFM XE-70) was used to determine the thicknesses of the nanosheets.

Electrochemical Measurements.

The working electrodes were prepared by mixing active materials (2D holey ZnMn₂O₄ nanosheets) and polyvinylidene difluoride (PVDF) at a weight ratio of 90:10 in N-methyl-2-pyrrolidinone (NMP). The slurries were then coated onto a copper foil. The as-prepared electrodes were dried under vacuum at 110° C. for 10 h. The loading of active materials was ˜0.8-1.0 mg cm⁻². After being sealed, the electrodes were assembled into coin cells (CR2032) in an argon-filled glovebox using Celgard 2320 as a separator, 1 mol L⁻¹ LiPF₆ in ethylenecarbonate (EC) and diethylenecarbonate (DEC) (1:1, v/v) as the electrolyte and Li metal as the counter electrode. The electrolyte used for the sodium-ion battery was 1 M NaClO₄ dissolved in propylene carbonate (PC) with 2% fluoroethlyene carbonate (FEC) additive. The assembled coin cells were tested on an Arbin battery test system with a voltage range of ˜0.01-3.0 V. For comparison, the free ZnMn₂O₄ samples were used as the active materials (denoted as control ZnMn₂O₄). Additionally, the free ZnMn₂O₄ samples were physically mixed with Super-P carbon in a weight ratio of 75:25 and used as the active materials (denoted as control ZnMn₂O₄+SP).

Results

Synthesis and Characterization of 2D Holey Transition Metal Oxide Nanosheets.

The general synthesis of the 2D holey transition metal oxide nanosheets via the template-directed self-assembly strategy is illustrated in FIG. 1. In a typical experiment, transition metal oxide precursors/reduced graphene oxide composites were prepared via solution-phase reaction between transition metal cations and graphene oxide, which was partially reduced to reduced graphene oxide (Xu C et al. J. Phys. Chem. C 2008, 112, 19841-19845; Nethravathi C and Rajamathi M. Carbon 2008, 46, 1994-1998). The resulting transition metal oxide precursors/reduced graphene oxide were then annealed to induce pyrolysis of reduced graphene oxide templates and formation of crystallized transition metal oxide nanoparticles, which partially agglomerated and linked with each other to form the 2D holey nanosheets. Taking 2D holey ZnMn₂O₄ nanosheets as an example, graphene oxide was dispersed in ethylene glycol solution by ultrasonication. Afterwards, Zn(CH₃COO)₂, and Mn(CH₃COO)₂ were added into the graphene oxide suspension. Stable and homogenous suspensions were obtained by stirring to ensure complete adsorption of Zn²⁺ and Mn²⁺ cations onto the surfaces of the graphene oxide. After refluxing, the black ZnMn₂O₄ precursors/reduced graphene oxide precipitates were washed and collected by centrifugation. A low magnification scanning transmission electron microscopy (STEM) image (FIG. 2a) shows a typical sheet-like morphology of the ZnMn₂O₄ precursors/reduced graphene oxide, indicating that reduced graphene oxide served as the template for supporting the ZnMn₂O₄ precursors. Higher-magnification STEM imaging (inset of FIG. 2a) indicated that the ZnMn₂O₄ precursors were well distributed on the reduced graphene oxide sheets. X-ray powder diffraction (XRD) patterns (FIG. 2b) suggest that the as-synthesized ZnMn₂O₄ precursors were amorphous. No diffraction peaks for reduced graphene oxide were observed, which suggested that the reduced graphene oxide was well exfoliated (Xiong P et al. ACS Nano 2014, 8, 8610-8616). The STEM (FIG. 2c) and corresponding elemental mappings (FIG. 2d) displayed uniform distributions of Zn, Mn, O, and C, further confirming the ZnMn₂O₄ precursors were substantially uniformly anchored on the surfaces of the reduced graphene oxide nanosheet templates.

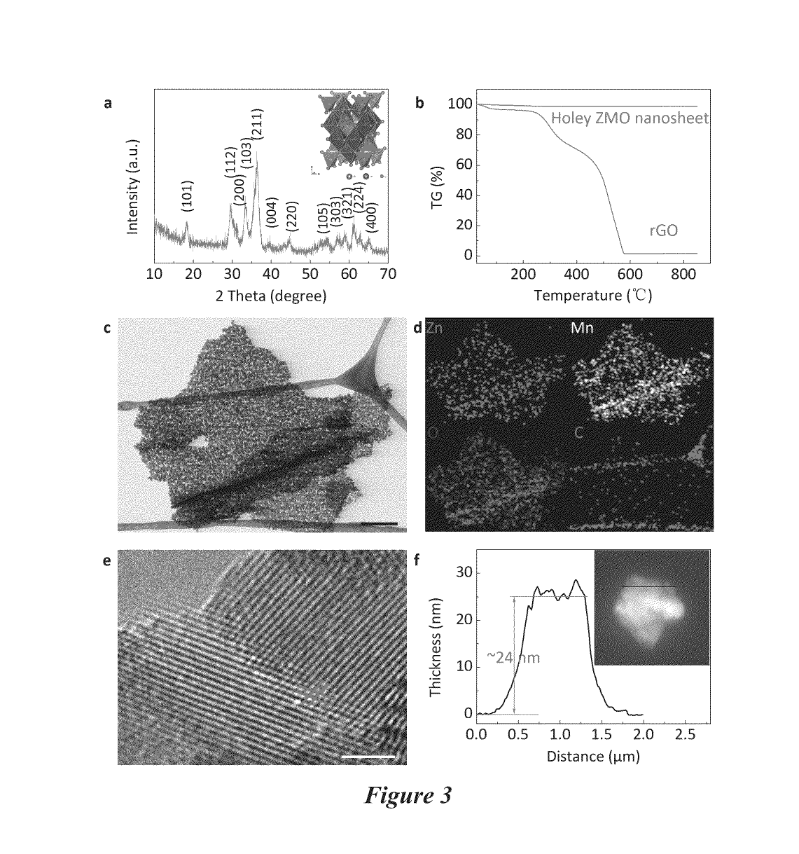

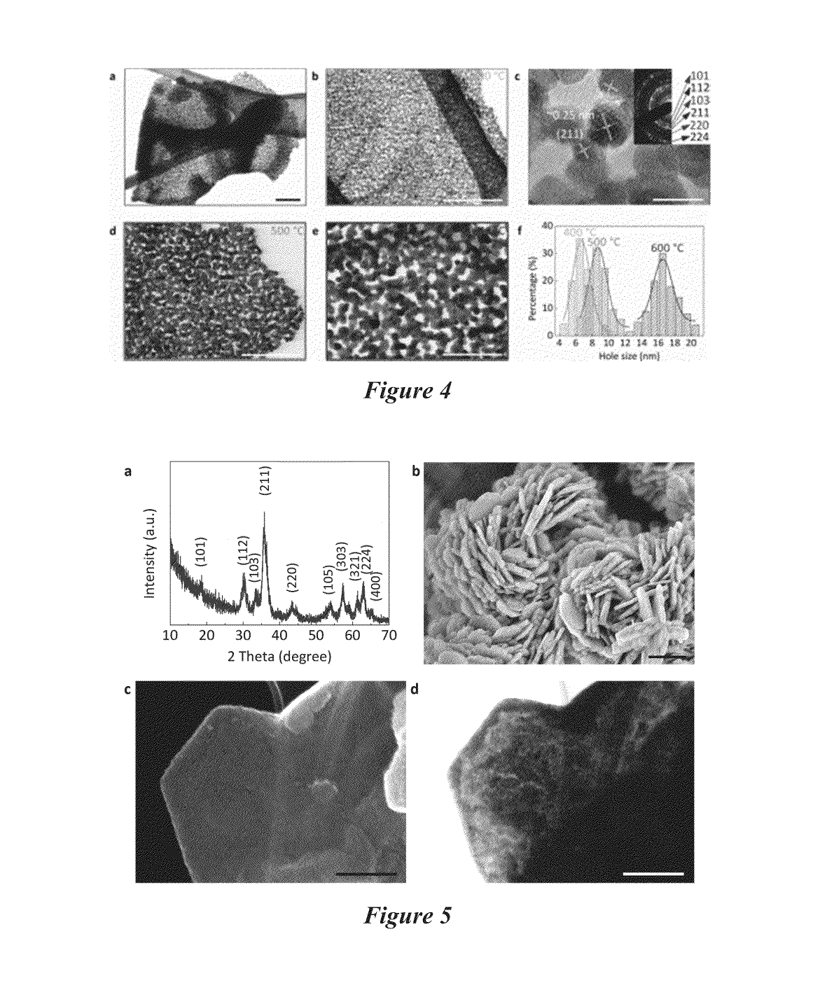

Post-calcination of the as-prepared ZnMn₂O₄ precursors/reduced graphene oxide at 400° C. in air induced the transformation of the amorphous precursors into crystalline ZnMn₂O₄ (FIG. 3a) and decomposition of reduced graphene oxide (FIG. 3b) without altering the 2D sheet morphology. STEM images (FIG. 4a and FIG. 3c) of the samples after calcination confirmed that the 2D nanosheet structures were well preserved in the final products. However, the nanosheets had been transformed from a dense structure with smooth surfaces (FIG. 2c) into holey nanosheets (FIG. 4b). High-resolution transmission electron microscopy (HRTEM) (FIG. 4c) revealed that the 2D holey nanosheets were composed of interconnected nanoparticles ˜10 nm in size. Moreover, the overlapping domains (FIG. 3e) suggested that the ZnMn₂O₄ nanoparticles were connected with each other. In addition, even after extended sonication during the preparation of the STEM specimen, the integrated nanosheets remained intact and no free ZnMn₂O₄ nanoparticles were observed, further suggesting strong interactions between the ZnMn₂O₄ nanoparticles. The clear lattice fringes of ˜0.25 nm (FIG. 4c) corresponded well to the (211) plane of the spinel ZnMn₂O₄. The diffuse concentric rings shown in the selected area electron diffraction (SAED) pattern (inset of FIG. 4c) indicated a polycrystalline structure. The diameters of the diffraction rings indexed to spinel ZnMn₂O₄, in agreement with the XRD analysis (FIG. 3a). The STEM (FIG. 3c) and corresponding elemental mapping (FIG. 3d) displayed substantially uniform distribution of Zn. Mn, and O, without any noticeable C; further demonstrating that the 2D holey nanosheets are composed of ZnMn₂O₄ nanoparticles. Atomic force microscopy (AFM) and thickness analysis (FIG. 31) revealed the same morphology as observed from STEM with a thickness of ˜24 nm, further demonstrating the 2D nanosheet structures.

The reduced graphene oxide templates can play a role in the formation of the 2D holey ZnMn₂O₄ nanosheets. First, reduced graphene oxide is a 2D template with sufficient oxygen-containing groups to ensure the template-directed growth of ZnMn₂O₄ precursors on its surface. Second, unlike most conventional template processes, where weak interactions exist between the precursors and template, herein the ZnMn₂O₄ precursors can be anchored covalently on the reduced graphene oxide through residual functional groups, such as carboxyl, hydroxyl, and epoxy groups (Wang H et al. J. Am. Chem. Soc. 2010, 132, 13978-13980; Liang Y et al. Nat. Mater. 2011, 10, 780-786). Thanks to the strong coupling interaction between ZnMn₂O₄ and reduced graphene oxide, the flexible reduced graphene oxide template can accommodate the structure and volume changes of the ZnMn₂O₄ nanoparticles and ensure that the ZnMn₂O₄ partially agglomerated and linked together to form the holey nanosheets during the thermal treatment. When free ZnMn₂O₄ was synthesized via the same method, without any graphene oxide added, as a control experiment, only an aggregated flower-like structure of assembled spinel ZnMn₂O₄ discs was obtained (FIG. 5a, b); no holey nanosheet structures were formed (FIG. 5c, d).

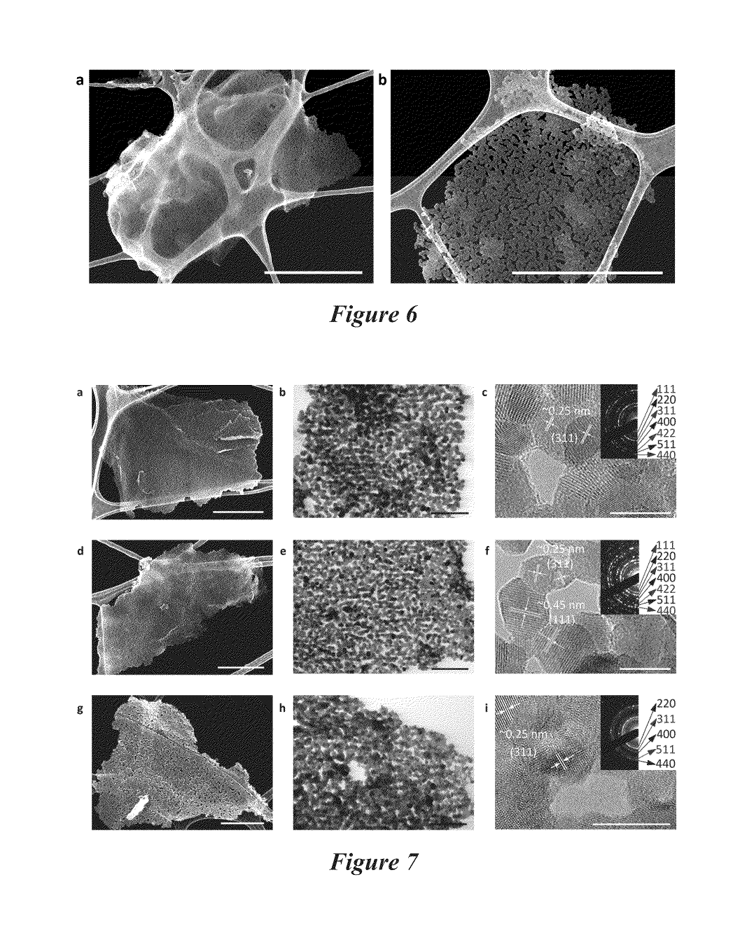

It can be desirable to control the hole size in the prepared holey nanomaterials, since the hole size can affect the performance of the prepared holey nanomaterials (Ren Y et al. J. Am. Chem. Soc. 2009, 132, 996-1004. Largeot C et al. J. Am. Chem. Soc. 2008, 130, 2730-2731). The hole size of 2D holey ZnMn₂O₄ nanosheets prepared by the strategy discussed herein can be controlled via the annealing temperature during the post-calcination process. The 2D holey nanosheet structure can be maintained at higher annealing temperatures (FIG. 6), but with different hole sizes. For comparison, 2D holey ZnMn₂O₄ nanosheets prepared by post-calcination at 400° C., 500° C., and 600° C., were examined under the same magnification (FIGS. 4b, d and e). The ZnMn₂O₄ particles grew bigger, resulting in larger a hole size, as the temperature increased. From FIG. 4f, it can be seen that the hole size of the 2D holey ZnMn₂O₄ nanosheets increased with increasing calcination temperature.

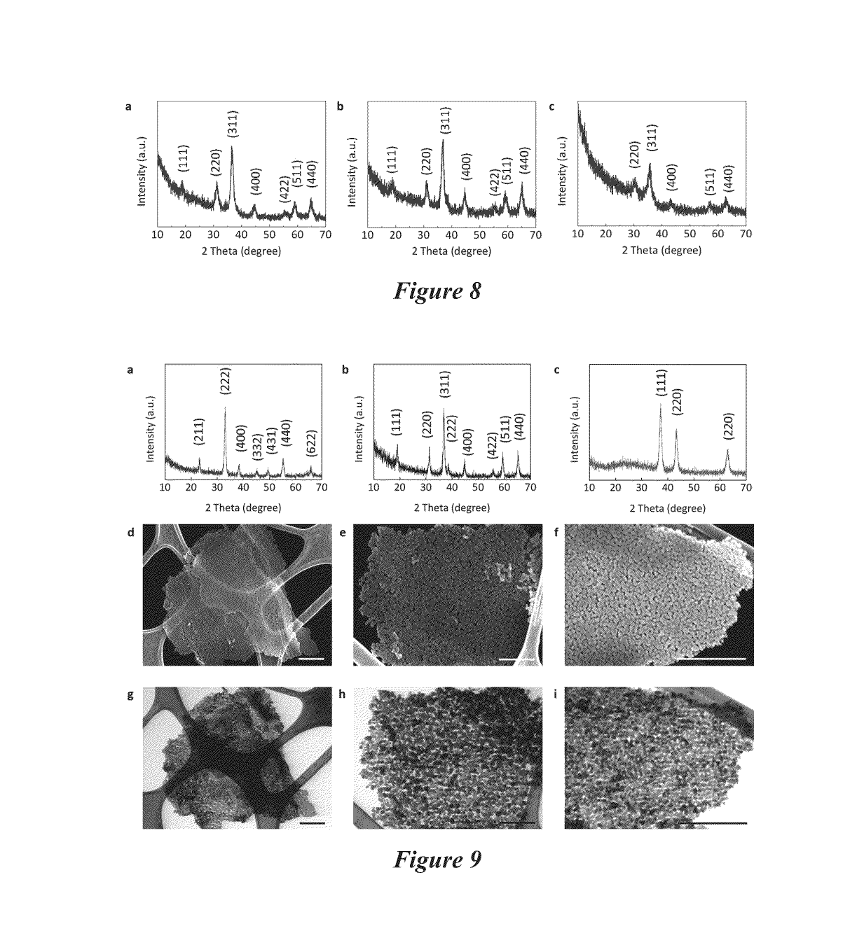

The strategy discussed herein was also used to prepare other 2D holey mixed transition metal oxide nanosheets. FIG. 7a, d and g show scanning electron microscopy (SEM) images of 2D holey ZnCo₂O₄, NiCo₂O₄ and CoFe₂O₄ nanosheets prepared by the same approach, respectively. STEM images of 2D holey ZnCo₂O₄, NiCo₂O₄ and CoFe₂O₄ nanosheets are displayed in FIGS. 7b, e and h, respectively. In comparison with the 2D ZnMn₂O₄ nanosheets shown in FIGS. 4a and b, similar 2D holey structures were observed in all these cases. High-resolution transmission electron microscopy (HRTEM) (FIGS. 7c, f and i) images revealed that these 2D holey nanosheets also consist of intimately interconnected transition metal oxide nanocrystallites. The lattice fringes (FIGS. 7c, f and i) and SAED patterns (inset of FIGS. 7c, f and i) confirmed that the 2D ZnCo₂O₄, NiC204 and CoFe₂O₄ nanosheets were composed of spinel ZnCo₂O₄, NiCo₂O₄ and CoFe₂O₄, respectively. These results were also consistent with the corresponding XRD results (FIG. 8). The strategy discussed herein was also used to synthesize 2D holey nanosheet structures of various simple transition metal oxides, such as Mn₂O₃, Co₃O₄, and NiO. XRD patterns, SEM, and STEM images (FIG. 9) show all these samples were obtained with high phase purity and well integrated 2D holey morphology.

2D Holey Transition Metal Oxide Nanosheets as Anodes for Lithium-Ion Battery.

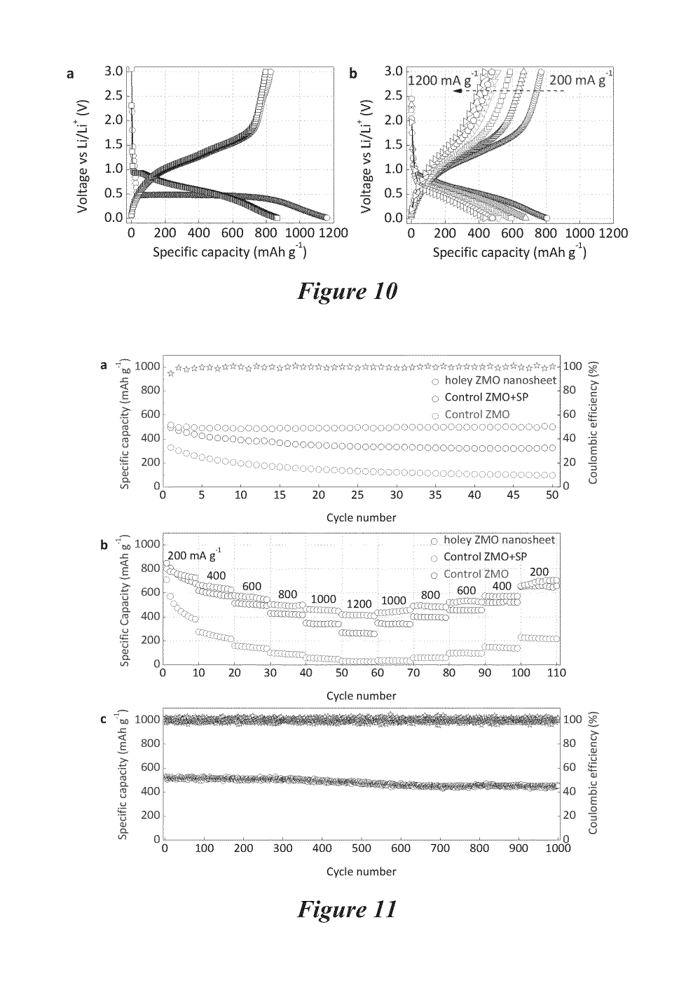

Recently, transition metal oxides (especially mixed transition metal oxides) have been studied as anode materials for rechargeable lithium-ion batteries owing to their larger specific capacities than conventional graphite (Yuan C et al. Angew. Chem. Int. Ed. 2014, 53, 1488-1504; Xiong P et al. ACS Nano 2014, 8, 8610-8616). As mentioned above, the 2D holey nanostructures discussed herein can have both 2D nanostructure and porosity, which can result in enhanced performance compared to conventional nanosheets with smooth surfaces or porous microscale materials. As such, the 2D holey mixed transition metal oxide nanosheets discussed herein were tested as anodes for lithium-ion batteries. FIG. 10a shows the charge and discharge curves of 2D holey ZnMn₂O₄ nanosheet based anodes for the first two cycles for a voltage range of 0.01 to 3.0 V. It should be noted that no carbon additives were needed for these electrodes. The voltage profile of the first Li⁺ charge comprised two main regions: a large plateau at 0.5 V, which can be associated with the irreversible reaction between Li⁺ and ZnMn₂O₄, followed by a smooth decrease to 0.01 V. The Li⁺ discharge curve showed no large plateau but only a sloping line due to the oxidation reactions of Mn⁰ and Zn⁰ to Mn²⁺ and Zn²⁺, respectively. The following charge and discharge curves reflected the reversible reactions between Mn⁰, Zn⁰ and Mn²⁺, Zn²⁺ and the Zn—Li alloying-de-alloying reactions. The initial capacity loss can be attributed to the formation of a solid electrolyte interface (SEI) (Peled E et al. J. Electrochem. Soc. 1996, 143, L4-L7). After several conditioning cycles, the Coulombic efficiency of the anodes increased to >98% (FIG. 11a), indicating good reversibility of the above conversion reactions.

To examine the specific capacity of the 2D holey nanosheet based anodes, the 2D holey ZnMn₂O₄ nanosheets were cycled at a current density of 800 mA g⁻¹ for 50 cycles (after an initial 2 cycles for activation). A stable specific capacity of ca. 510 mA h g⁻¹ (all specific capacities estimated based on mass of active materials) was observed after 50 cycles for the 2D holey nanosheet anode (FIG. 11a). For comparison, two control anodes, ZnMn₂O₄ and ZnMn₂O₄+SP (free ZnMn₂O₄ physically mixed with Super-P carbon), were also cycled under the same conditions. Specific capacities of ca. 326 and ca. 97 mA h g⁻¹ were obtained after 50 cycles for the control ZnMn₂O₄+SP and ZnMn₂O₄ anodes, respectively (FIG. 11a). The rate capability of the as-prepared 2D holey ZnMn₂O₄ nanosheet based anodes was also compared with that for the control ZnMn₂O₄+SP and ZnMn₂O₄ anodes (FIG. 11b). For the first few cycles at a low current density of 200 mA g⁻¹, the 2D holey ZnMn₂O₄ nanosheets showed an average specific capacity of ca. 751 mA h g⁻¹ (FIG. 10b). Even at a high current density of 1200 mA g⁻¹, the specific capacity of the 2D holey nanosheet anode was ca. 434 mA h g⁻¹ (FIG. 10b), with a ˜58% capacity retention. An average specific capacity of ca. 710 mA h g⁻¹ at 200 mA h g⁻¹ was retained for the 2D holey nanosheet anode after 110 cycles of charge and discharge at various current densities (FIG. 11b). However, only ˜32% and ˜6% capacity retention were obtained for the control ZnMn₂O₄+SP and ZnMn₂O₄ anodes, respectively, as the current density was increased from 200 to 1200 mA h g⁻¹ (FIG. 11b).

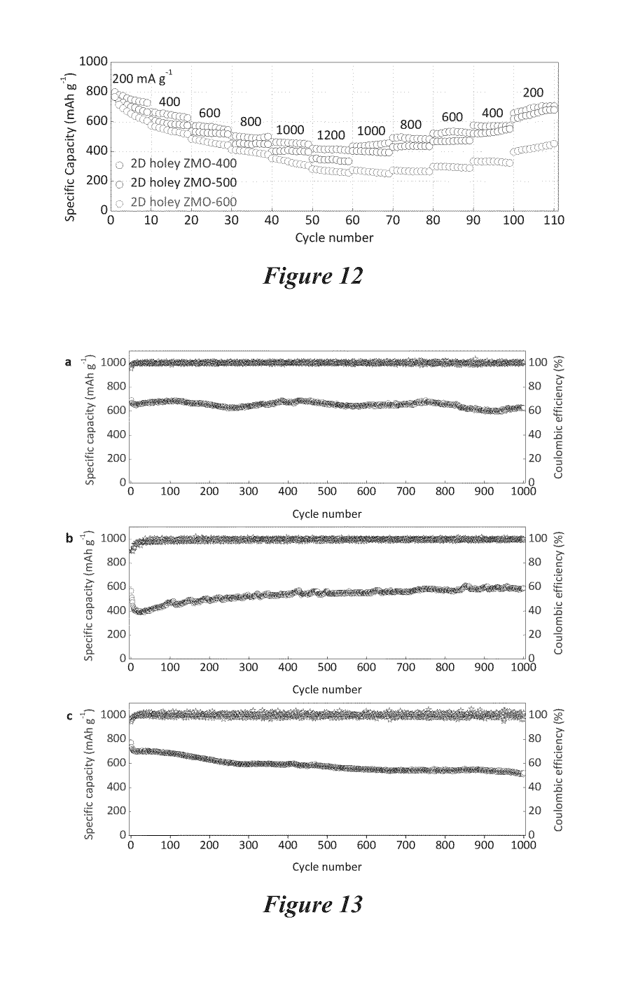

The rate performance of anodes based on 2D holey ZnMn₂O₄ nanostructures prepared at different temperatures was also examined (FIG. 12). The 2D holey ZnMn₂O₄ nanosheet samples treated at 400° C. and 500° C. showed comparable performances, whereas a decrease in the rate performance was observed for the 2D holey ZnMn₂O₄ nanosheet sample prepared using a calcination temperature of 600° C. The decreased performance for the 2D holey ZnMn₂O₄ nanosheet sample calcined at 600° C. can be due to the larger particle size and more aggregated structure of said sample.

The long-term cycling stability of the 2D holey ZnMn₂O₄ nanosheet based anodes was measured at a current rate of 1000 mA g⁻¹ for 1000 charge/discharge cycles (FIG. 11c). After an initial discharge capacity of 525 mA h g⁻¹, the 2D holey nanostructures displays capacity retentions of 97.7%, 95.4% and 89.3% at the end of 100, 200 and 500 cycles, respectively (FIG. 11c). Furthermore, after 1.000 cycles the capacity retention of the 2D holey nanostructures was 86.2%, which corresponds to a capacity decay of 0.0138% per cycle, representing the best performance for long-cycle lithium-ion batteries with transition metal oxide-based anodes to date. The average Coulombic efficiency of the 2D holey nanostructures from the 1st to 1,000th cycle was 99.8% (FIG. 11c).

2D holey CoFe₂O₄, ZnCo₂O₄, and NiCo₂O₄ nanosheets were also examined as anodes for lithium storage. All these 2D holey nanosheet anodes displayed high cycling stability (FIG. 13a-c), suggesting that the strategy discussed herein can be a general route for synthesis of 2D holey nanostructures with high lithium storage ability. Notably, the cycling stability and rate capability of the 2D holey mixed transition metal oxide nanosheet anodes discussed herein are superior to those of the previously reported mixed transition metal oxide nanostructure anodes, and even comparable to mixed transition metal oxide/carbon hybrid anodes (Table 1). These findings suggest these 2D holey nanosheets can be useful for practical energy storage applications.

TABLE 1
Summary of properties of mixed transition metal oxide based anodes for lithium ion batteries.

| | Cycling stability | Rate capability | |
|---|---|---|---|
| Active Materials | (mA h g⁻¹) | (mA h g⁻¹) | Reference |
| ZnMn₂O₄ | | 555 at 200 mA g⁻¹ | Deng Y et al. J. Mater. Chem. |
| nanoparticles | | 280 at 2400 mA g⁻¹ | 2011, 21, 11987-11995. |
| ZnMn₂O₄ | 350 at 1000 mA g⁻¹ | | Kim SW et al. Nano Res. 2011, |
| nanowires | (40 cycles) | | 4, 505-510. |
| ZnMn₂O₄ | 517 at 500 mA g⁻¹ | 810 at 50 mA g⁻¹ | Bai Z et al. Nanoscale 5, |
| nanorods | (100 cycles) | 457 at 1000 mA g⁻¹ | 2442-2447 (2013). |
| ZnMn₂O₄ | 784.3 at 100 mA g⁻¹ | 644.6 at 100 mA g⁻¹ | Kim JG et al. ACS Appl. Mater. |
| tubules | (100 cycles) | 243.5 at 3200 mA g⁻¹ | Interfaces 2013, 5, |
| | | | 11321-11328. |
| Flower-like | 626 at 100 mA g⁻¹ | | Xiao L et al. J. Power Sources |
| ZnMn₂O₄ | (50 cycles) | | 2009, 194, 1089-1093. |
| microstructures | | | |
| ZnMn₂O₄ hollow | 607 at 400 mA g⁻¹ | 791 at 200 mA g⁻¹ | Zhou L et al. J. Mater. Chem. |
| microspheres | (100 cycles) | 361 at 1600 mA g⁻¹ | 2012, 22, 827-829. |
| ZnMn₂O₄ hollow | 750 at 400 mA g⁻¹ | 683 at 600 mA g⁻¹ | Zhang G et al. Adv. Mater. |
| microspheres | (120 cycles) | 396 at 1200 mA g⁻¹ | 2012, 24, 4609-4613. |
| ZnCo₂O₄ | 894 at 60 mA g⁻¹ | | Sharma Y et al. Adv. Funct. |
| nanoparticles | (60 cycles) | | Mater. 2007, 17, 2855-2861. |
| Porous ZnCo₂O₄ | 841 at 1000 mA g⁻¹ | | Luo W et al. J. Mater. Chem. |
| nanotubes | (30 cycles) | | 2012, 22, 8916-8921. |
| Porous ZnCo₂O₄ | 750 at 80 mA g⁻¹ | | Qiu Y et al. J. Mater. Chem. |
| nanoflakes | (50 cycles) | | 2010, 20, 4439-4444. |
| ZnCo₂O₄ | 721 at 100 mA g⁻¹ | 970 at 100 mA g⁻¹ | Hu L et al. J. Mater. Chem. A |
| microsphere | (80 cycles) | 435 at 2000 mA g⁻¹ | 2013, 1, 5596-5602. |
| NiCo₂O₄ | 1058 at 100 mA g⁻¹ | | Guo H et al. Nanoscale 2014, |
| nanocubes | (100 cycles) | | 6, 5491-5497. |
| Flower-like | 640 at 500 mA g⁻¹ | 680 at 250 mA g⁻¹ | Li L et al. J. Mater. Chem. A |
| NiCo₂O₄ | (60 cycles) | 420 at 2000 mA g⁻¹ | 2013, 1, 10935-10941. |
| microstructures | | | |
| NiCo₂O₄ | 705 at 800 mA g⁻¹ | 1260 at 100 mA g⁻¹ | Li J et al. ACS Appl. Mater. |
| microsphere | (500 cycles) | 393 at 1600 mA g⁻¹ | Interfaces 2013, 5, 981-988. |
| CoFe₂O₄ | 733.5 at 200 mA g⁻¹ | 790.5 at 200 mA g⁻¹ | Xiong QQ et al. J. Power |
| microsphere | (50 cycles) | 744.1 at 1000 mA g⁻¹ | Sources 2014, 256, 153-159. |
| ZnMn₂O₄/ | 707 at 100 mA g⁻¹ | 980 at 100 mA g⁻¹ | Zheng Z et al. J. Mater. Chem. |
| graphene | (50 cycles) | 440 at 2000 mA g⁻¹ | A 2014, 2, 149-154. |
| ZnCo₂O₄/ | 1100 at 500 mA g⁻¹ | | Qu B et al. ACS Appl. Mater. |
| Ni foam | (50 cycles) | | Interfaces 2013, 6, 731-736. |
| ZnCo₂O₄/ | 900 at 416 mA g⁻¹ | 1180 at 111 mA g⁻¹ | Long H et al. J. Mater. Chem. |
| Ni foam | (50 cycles) | 485 at 1111 mA g⁻¹ | A 2014, 2, 3741-3748. |
| ZnCo₂O₄/ | 1180 at 180 mA g⁻¹ | | Liu B et al. Nano Res. 2013, 6, |
| carbon fibers | (100 cycles) | | 525-534. |
| ZnCo₂O₄/ | 1200 at 200 mA g⁻¹ | 1200 at 180 mA g⁻¹ | Liu B et al. Nano Lett. 2012, |
| carbon cloth | (160 cycles) | 605 at 4500 mA g⁻¹ | 12, 3005-3011. |
| NiCo₂O₄/ | 816 at 100 mA g⁻¹ | 396 at 800 mA g⁻¹ | Chen Y et al. J. Mater. Chem. |
| graphene | (70 cycles) | 974 at 100 mA g⁻¹ | A 2014, 2, 4449-4456. |
| CoFe₂O₄/ | 1045 at 200 mA g⁻¹ | 1137.6 at 200 mA g⁻¹ | Zhang Z et al. J. Mater. Chem. |
| carbon nanotubes | (100 cycles) | 621.7 at 2000 mA g⁻¹ | A 2013, 1, 7444-7450. |
| CoFe₂O₄/ | 565 at 800 mA g⁻¹ | 1290 at 50 mA g⁻¹ | Liu S et al. J. Mater. Chem. |
| graphene | (300 cycles) | 730 at 800 mA g⁻¹ | 2012, 22, 19738-19743. |
| 2D holey | 510 at 800 mA g⁻¹ | 751 at 200 mA g⁻¹ | |
| ZnMn₂O₄ | (50 cycles) | 434 at 1200 mA g⁻¹ | |
| nanosheets | 453 at 1000 mA g⁻¹ | | |
| | (1000 cycles) | | |
| 2D holey | 627 at 1000 mA g⁻¹ | | |
| ZnCo₂O₄ | (1000 cycles) | | |
| nanosheets | | | |
| 2D holey | 593 at 1000 mA g⁻¹ | | |
| NiCo₂O₄ | (1000 cycles) | | |
| nanosheets | | | |
| 2D holey | 521 at 1000 mA g⁻¹ | | |
| CoFe₂O₄ | (1000 cycles) | | |
| nanosheets | | | |

2D Holey Transition Metal Oxide Nanosheets as Anodes for New-Generation Batteries Beyond Lithium-Ion.

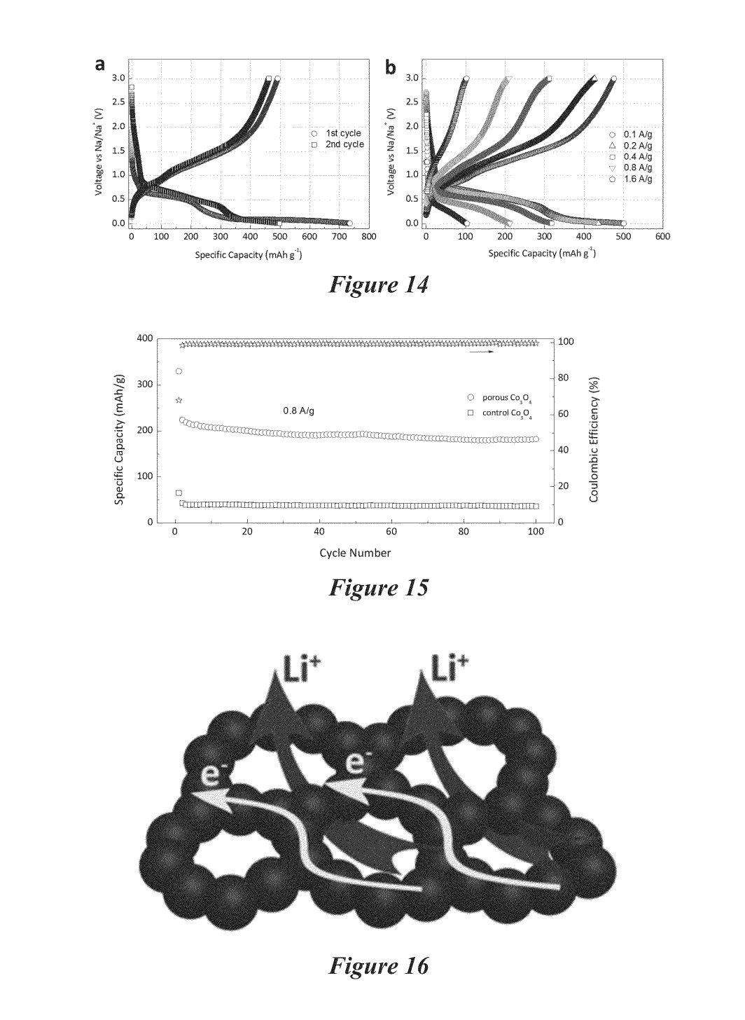

Transition metal oxides have also been explored as electrode materials for beyond lithium-ion batteries, such as sodium-ion and lithium air batteries, owing to their large specific capacities and electrochemical activity (Jiang Y et al. Nano Energy 2014, 5, 60-66; Alcántara R et al. Chem. Mater. 2002, 14, 2847-2848; Chen L et al. J. Mater. Chem. A, 2015, 3, 3620-3626). The 2D holey transition metal oxide nanosheets discussed herein can have both 2D nanostructure and porosity, which can result in improved electrochemical performance compared to conventional nanosheets with smooth surfaces and porous microscale materials. As such, the 2D holey transition metal oxide nanosheets were tested as anodes for sodium-ion batteries. FIG. 14a shows the charge and discharge curves of 2D holey Co₃O₄ nanosheet based anodes for the first two cycles at a voltage range of 0.01 to 3.0 V. In the discharge curve of first cycle, the large plateau around 0.54 V could be assigned to the reduction of Co₃O₄ and formation of a solid-electrolyte interphase (SEI) film (Jian Z et al. J. Mater. Chem. A 2014, 2, 13805-13809). The 2D holey Co₃O₄ nanosheets delivered a discharge and charge capacity of ˜740 mAh g⁻¹ and ˜490 mAh g⁻¹, respectively, at the current density of 0.1 A g⁻¹. FIG. 14b shows the charge and discharge curves of 2D holey Co₃O₄ nanosheet based anodes at various current densities. The 2D holey Co₃O₄ nanosheets delivered a specific capacity of 500 mAh g⁻¹, 440 mAh g⁻¹, 320 mAh g⁻¹, 220 mAh g⁻¹, and 110 mAh g⁻¹ at current densities of 0.1 A g⁻¹, 0.2 A g⁻¹, 0.4 A g⁻¹, 0.8 A g⁻¹, and 1.6 A g⁻¹, respectively, representing a good rate capability for sodium-ion storage.

To examine the cycling performance of the 2D holey nanosheet based anodes, the 2D holey Co₃O₄ nanosheets were cycled at a current density of 800 mA g⁻¹ for 100 cycles. A stable specific capacity of ca. 200 mA h g⁻¹ (all specific capacities estimated based on mass of active materials) was observed after 100 cycles for the 2D holey Co₃O₄ nanosheet anode (FIG. 15). For comparison, the control anodes, Co₃O₄ without a porous structure, were also cycled under the same conditions. Specific capacities of ca. 40 mA h g⁻¹ were obtained after 100 cycles for the control anodes (FIG. 15). These findings suggest these 2D holey nanosheets can be promising material platforms to fabricate the high performance sodium-ion batteries.

### DISCUSSION

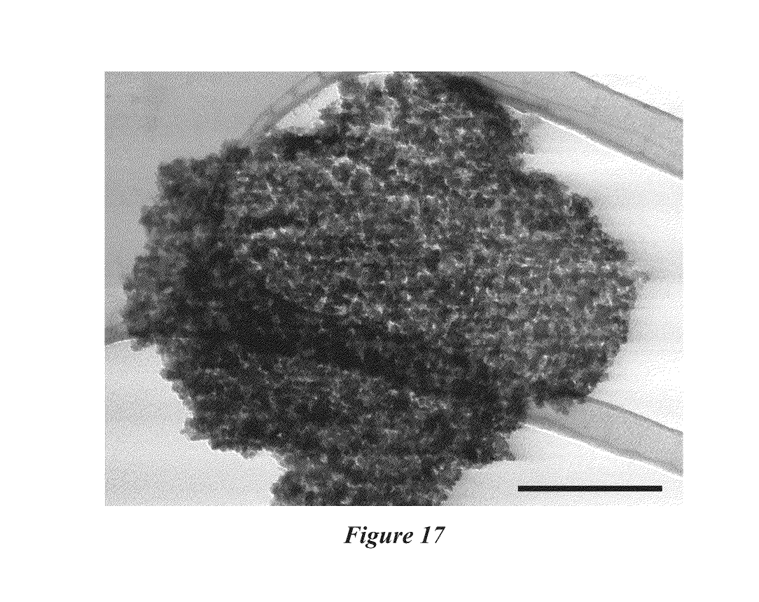

The high rate capability and cycling stability observed for the 2D holey ZnMn₂O₄ nanosheets can be attributed to the combinative merits of both the 2D nanostructure and variable porosity. Firstly, the interconnected holes on the surfaces of 2D nanosheets can enable diffusion of liquid electrolyte into the electrode materials and can reduce the Li⁺ ion diffusion length (Ren Y et al. J. Am. Chem. Soc. 2009, 132, 996-1004; Fang Y et al. J. Am. Chem. Soc. 2013, 135, 1524-1530). The diffusion of Li⁺ ions through the nanoholes and the transport of electrons along the interconnected nanocrystals of the 2D holey nanosheets are shown schematically in FIG. 16. These processes can be helpful when a battery using the 2D holey nanosheets is charged or discharged at a high current. Secondly, the large surface areas and short diffusion lengths of the 2D nanosheets can facilitate effective Li⁺ ion transport (Seo J W et al. Angew. Chem. Int. Ed. 2007, 46, 8828-8831). Finally, these interconnected holes can also alleviate the strain generated from volume change during electrochemical cycling, thus improving the cycling stability and Coulombic efficiency (Li Y et al. Adv. Funct. Mater. 2012, 22, 4634-4667: Ge M et al. Nano Lett. 2013, 14, 261-268; Guo B et al. Energy Environ. Sci. 2014, 7, 2220-2226). As shown in FIG. 17, the structural integrity and holey features of the 2D holey ZnMn₂O₄ nanosheets were still preserved after 100 cycles (STEM sample prepared by opening the cell was opened after severe cycling, washing the 2D holey ZnMn₂O₄ nanosheet anode with dimethyl carbonate (DMC), sonicating in ethanol, and then drop drying the ethanol suspension onto a TEM grid). The short diffusion length, reduced transport resistance, and chemically active exposed surfaces of the 2D holey nanostructure can make these materials attractive for applications including supercapacitors, catalysis, sensors, etc.

In conclusion, a general strategy employing graphene oxide as a sacrificial template to prepare various 2D holey transition metal oxide nanosheets, including mixed transition metal oxides and simple transition metal oxides, was discussed herein. These 2D holey nanosheets exhibited enhanced performance for lithium storage.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

What is claimed is:

1. A two-dimensional (2D) nanosheet comprising a continuous transition metal oxide phase permeated by a plurality of pores, wherein the plurality of pores have an average characteristic dimension of from 1 nm to 30 nm.

2. The 2D nanosheet of claim 1, wherein the transition metal oxide comprises a metal selected from the group consisting of Zn, Mn, Co, Ni, Fe, and combinations thereof

3. The 2D nanosheet of claim 2, wherein the transition metal oxide comprises a transition metal oxide selected from the group consisting of ZnMn₂O₄, ZnCo₂O₄, NiCo₂O₄, CoFe₂O₄, Mn₂O₃, Co₃O₄, NiO, and combinations thereof.

4. The 2D nanosheet of claim 1, wherein the 2D nanosheet has a thickness of 30 nm or less.

5. The 2D nanosheet of claim 1, wherein the 2D nanosheet has an aspect ratio of at least 25:1.

6. The 2D nanosheet of claim 1, wherein the plurality of pores have an average characteristic dimension of from 4 nm to 20 nm.

7. The 2D nanosheet of claim 1, wherein the 2D nanosheet has a surface area of from 20 m²/g to 200 m²/g.

8. The 2D nanosheet of claim 1, wherein the 2D nanosheet has a surface porosity of from 10% to 50%.

9. The 2D nanosheet of claim 1, wherein the 2D nanosheet is substantially free of carbon.

10. An electrode comprising the 2D nanosheet of claim 1.

11. The electrode of claim 10, wherein the electrode has a specific capacity of 350 mA h g⁻¹ or more at a current density of 1000 mA g⁻¹ over 1000 charge/discharge cycles.

12. The electrode of claim 10, wherein the electrode has a capacity retention of 85% or more after 1000 charge/discharge cycles.

13. The electrode of claim 10, wherein the electrode has a Coulombic efficiency of 99% or more over 1000 charge/discharge cycles.

14. A battery comprising
a first electrode comprising the 2D nanosheet of claim 1:
a second electrode; and
an electrolyte.

15. The battery of claim 14, wherein the first electrode has a specific capacity of 350 mA h g⁻¹ or more at a current density of 1000 mA g⁻¹ over 1000 charge/discharge cycles.

16. The battery of claim 14, wherein the first electrode has a capacity retention of 85% or more after 1000 charge/discharge cycles.

17. The battery of claim 14, wherein the first electrode has a Coulombic efficiency of 99% or more over 1000 charge/discharge cycles.

18. The battery of claim 14, wherein the electrolyte comprises a Li⁺ electrolyte, a Mg⁺ electrolyte, a Na⁺ electrolyte, or combinations thereof.

19. A method of making the 2D nanosheet of claim 1 comprising:
(i) reacting a graphene template with a transition metal compound to form a nanosheet precursor; and
(ii) calcining a nanosheet precursor to form the 2D nanosheet.

20. The method of claim 19, wherein reacting the graphene template with the transition metal compound comprises contacting the graphene template with the transition metal compound and reducing the transition metal compound.

21. The method of claim 19, wherein reacting the graphene template with the transition metal compounds comprises heating.
